(19) United States
(12) Patent Application Publication
(10) Pub. No.: US 2014/0332325 A1
(43) Pub. Date: Nov. 13, 2014

(54) FILLER PIECE FOR AN ELEVATOR COUNTER-WEIGHT

(71) Applicant: SIC LAZARO, S.L., CORELLA (Navarra) (ES)

(72) Inventor: Javier Ignacio LAZARO GOICOECHEA, CORELLA (Navarra) (ES)

(73) Assignee: SIC LAZARO, S.L., CORELLA (Navarra) (ES)

(21) Appl. No.: 14/272,724

(22) Filed: May 8, 2014

(30) Foreign Application Priority Data
May 9, 2013 (ES) P201330667
May 5, 2014 (ES) P201430646

(51) Int. Cl. B66B 17/12

(52) U.S. Cl. CPC B66B 17/12
USPC 187/405

(57) ABSTRACT

Each filler piece (1) for an elevator counter-weight, the subject matter of the invention, comprises a central metal core (5) and a concrete casing (4), such that a piece (1) is obtained having a target density whose value is comprised between 4 and 5.5 g/cm³ by combining the concrete of the casing (4) and the central metal core (5). The percentages by weight of metal material in the core (5) and concrete in the casing (4) are a function of the target density to be reached in each piece (1), said percentages are determined by a relationship between the density of the concrete of the casing (4), the density of the metal material of the core (5) and the target density of the piece (1).

### OBJECT OF THE INVENTION

The present invention relates to a filler piece for an elevator counter-weight manufactured with a specially-developed high-density material. This filler piece is used in all of the known types of elevators, for example: lifters, freight elevators, etc.

### TECHNICAL PROBLEM TO BE SOLVED AND BACKGROUND TO THE INVENTION

A counter-weight is a mass which, by the effect of gravity, is used to balance certain forces in a direction. Specifically, a counter-weight in an elevator is placed in order to balance the weight of the cab and part of the useful load that said cab is able to withstand.

In such a way that when the elevator moves upward, the counter-weight moves downward, and vice versa. As such, the motor moving the cab only has to lift the difference between the load of the cab and the counter-weight. The use of counter-weights reduces the machine power used.

At present, the filler pieces used in counter-weights are incorporated in frames, the dimensions of these frames being limited to the free space inside the building's elevator shaft, such that the dimensions of the pieces are therefore limited to the dimensions of the frame that will contain them.

Since elevator shafts tend to be small, the most important parameter to consider when designing a counter-weight is the density of the material making up the pieces that are placed in the frame, as these pieces are the ones that provide the mass that balances the weight of the cab and part of the useful load.

At present, different types of pieces can be used for the filling of an elevator counter-weight frame:
high-density concrete pieces: made up of concrete constituted by slag and a binder such as cement,
steel or foundry casting pieces,
a combination of concrete pieces and iron or steel pieces.

The density of the counter-weight filler pieces used to oppose the weight of an elevator cab ranges between 2.3 g/cm³, which corresponds to a frame loaded just with concrete pieces, and 7.85 cm³, which corresponds to a frame loaded just with steel pieces.

However, the load to be balanced out with the counter-weights of an elevator, and the space available for said counter-weight in the elevator shaft, makes it so that the filler of the counter-weight has a density typically ranging between 4.5 and 5.5 g/cm³. In order to adjust the desired counter-weight density, the counter-weight frame is loaded with a combination of concrete pieces and steel pieces that supply the desired density.

The geometric shape of the filler pieces of the frame is determined by the manufacturer of the elevator; likewise, the components of the counter-weights, i.e. the current frame and filler pieces, must comply with very strict quality and tolerance requirements, in terms of their dimensions, geometry and resistance.

There are several problems with the current counter-weights:
in the steel pieces, the final geometry is obtained by cutting, which means that material is wasted, thus raising the price of the product; likewise, subsequent deburring must be carried out in order to remove the burrs of excess material;
moreover, these steel pieces are exposed pieces, which, in addition, must be handled by hand when the elevator is assembled. For this reason, the cutting and finishing of these pieces must have a certain degree of quality, thus limiting the speed of said cutting along with the productivity in the manufacture of these pieces.
normally, packages are made with these pieces in order to be dispatched to clients; each package constitutes the load of a counter-weight frame, and so said package must by made by combining steel pieces and concrete pieces. Putting together packages with both types of pieces is a tedious task involving additional costs.

In addition, to get the maximum use out of the metal material used to manufacture the counter-weight piece of the core, said material must be previously worked in a machine to fashion the core out of a metal piece with larger dimensions.

The necessary level of resistance, in the pieces made up of a piece-like metal core and a concrete casing, is difficult to obtain.

### DESCRIPTION OF THE INVENTION

The invention described herein discloses a counter-weight piece of the sort used in elevators, in which, due to its configuration and its design, the manufacturing and handling costs are reduced and the operation of preparing the packages for dispatching is simplified.

A filler piece for an elevator counter-weight which comprises a core of metal material and a concrete casing, wherein said piece comprises a combination of the concrete of the casing and the metal material of the core that has a target density comprised between 4.0 g/cm³ and 5.5 g/cm³.

The metal material of the core of the filler piece for an elevator counter-weight is a granular material.

In the filler piece for an elevator counter-weight, proportions by weight of granular metal material and concrete are a function of the target density, where the proportion by weight of concrete is given by the following expression:

$${χ}_{HDC} = \frac{{ρ}_{HDC}}{{ρ}_{t}} ( \frac{{ρ}_{Metal} - {ρ}_{t}}{{ρ}_{Metal} - {ρ}_{HDC}} )$$

where:
χ_{HDC} is the percentage by weight of concrete, and has a value that is comprised between 0 and 1,
ρ_{HDC} is a final density of the compacted and hardened concrete,
ρ_{Metal} is a density of the metal material employed,
ρₜ is the target density of the combination concrete—metal material of each filler piece (1).

The proportion of metal material of the filler piece for an elevator counter-weight is given by the following expression:

$${χ}_{Metal} = \frac{{ρ}_{Metal}}{{ρ}_{t}} ( \frac{{ρ}_{t} - {ρ}_{HDC}}{{ρ}_{Metal} - {ρ}_{HDC}} )$$

where:
χ_{Metal} is a percentage by weight of measured out granular metal material, and has a value that is comprised between 0 and 1,
ρ_{HDC} is the final density of the compacted and hardened concrete,
ρ_{Metal} is the density of the metal material employed,
ρₜ is the target density of the combination concrete—metal material of each filler piece (1).

The concrete of the casing of the filler piece for an elevator counter-weight comprises iron and steel aggregate and a binder, and may further comprise at least one type of reinforcement fiber and at least one plasticizing additive.

The binder of the concrete of the casing of the filler piece for an elevator counter-weight is cement, and is measured out with a percentage by weight over the mass of concrete according to the expression:

$${χ}_{cement} = \frac{c}{{ρ}_{t} {χ}_{HDC}}$$

where:
c is a parameter comprised between 0.2 and 0.5 tn/m³;
χ_{cement} cement is a percentage by weight of cement over the mass of concrete:
ρₜ is the target density of the mixture of concrete—granular metal material of each filler piece (1); and
χ_{HDC} is the percentage by weight of concrete, and has a value that is comprised between 0 and 1.

The binder of the concrete of the casing of the filler piece for an elevator counter-weight comprises cement and resins.

The resins of the binder used in the concrete of the filler piece for an elevator counter-weight comprise copolymers of vinyl acetate and ethylene, such that a percentage by weight of the resins with respect to a total weight of the cement is in a range comprised between 2% and 6%.

The binder of the concrete of the casing of the filler piece for an elevator counter-weight comprises, in one alternative, cement and microsilica, the microsilica being measured out at 10% over the amount of cement.

The reinforcement fiber of the concrete of the casing of the filler piece for an elevator counter-weight is of the short fiber type, measured out in a range comprised between 0 and 900 grams per ton of concrete.

The plasticizing additive of the concrete of the casing of the filler piece for an elevator counter-weight is approximately 1.5% by weight over the total cement weight.

### DESCRIPTION OF THE DRAWINGS

To complete the description, and for the purpose of helping to make the characteristics of the counter-weight, subject matter of the invention, more readily understandable, the present specification is accompanied by a set of figures constituting an integral part of the same, which by way of illustration and not limitation represent the following:

FIG. 1 is a perspective view of a frame in which pieces are placed to form an elevator counter-weight.

FIG. 2 is a front view of a counter-weight of the kind that are filled with pieces of the kind known in the state of the art, combining steel and concrete pieces.

FIG. 3 is a perspective view of a metal piece of the kind known in the state of the art, used to fill a counter-weight.

FIG. 4 is a front view of a counter-weight filled with filler pieces of the sort which are the subject matter of the invention.

FIG. 5 is a perspective view of a filler piece that is the subject matter of the invention, according to a first embodiment.

FIG. 6 is a perspective view of a piece that is the subject matter of the invention, according to a second embodiment.

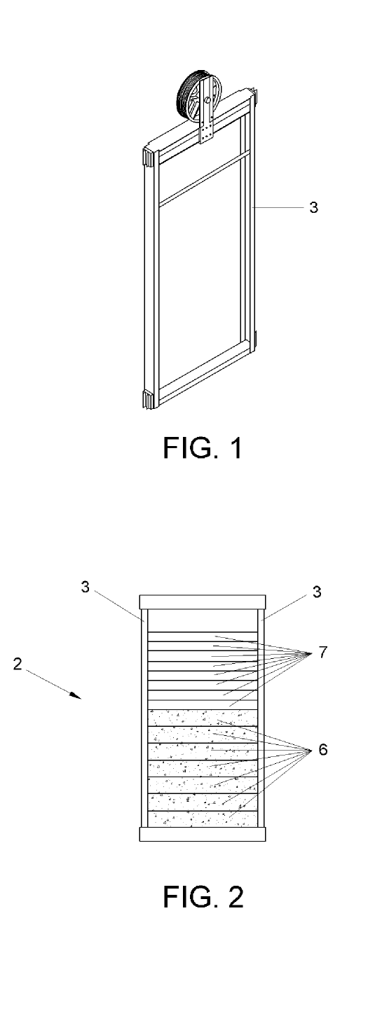

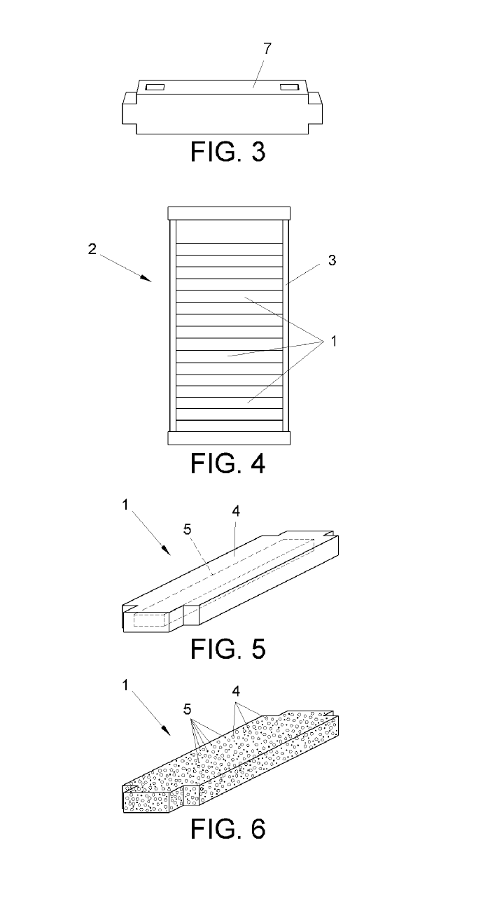

The various numerical references found in the figures correspond to the following elements:
1.—filler piece, subject matter of the invention,
2.—counter-weight,
3.—frame,
4.—casing,
5.—core,
6.—known concrete piece,
7.—known metal piece,

### PREFERRED EMBODIMENT OF THE INVENTION

The subject matter of the present description is based on a high-density piece (1) for filling a counter-weight (2), the counter-weight (2) being of the sort employed in elevators, lifters, freight elevators, etc. The configuration and design of the filler pieces (1) reduces the manufacturing and handling costs, and facilitates the preparation of packages for dispatching.

The high-density filler piece (1) is made up of a concrete casing (4), inside of which a core (5) of metal material has been placed (made up of one or more steel or iron parts).

With the filler pieces (1) that are the subject matter of the invention, it is not necessary to combine known concrete pieces (6) and known metal pieces (7) to fill the frame (3), as is the case with the currently known counter-weights (2), said frame (3) can be filled only with the filler pieces (1) that are the subject matter of the invention.

In this way, according to a first embodiment of the filler piece that is the subject matter of the invention, the metal material that makes up the core (5) may have a very simple geometry, thus reducing the scrap metal that is generated with respect to the manufacture of the known metal pieces (7), whereas by means of the concrete casing (4) the filler piece (1) is given a (more complex) geometric shape which may be adapted to the demands of the elevator manufacturer. In accordance with the design of the filler piece (1), the metal parts that make up its core (5) cease to be exposed pieces in the new design, such that cut quality is no longer relevant. This enables higher cutting speed, in addition to eliminating the deburring operation required by a known metal piece (7).

To manufacture the filler pieces (1) that are the subject matter of the invention, according to a first embodiment, an element made of metal material is used as a central core (5) with the simplest shape possible, so as to get the maximum use out of the metal material, thus reducing the amount of scrap generated when cutting said metal material. This use is optimal when long steel products are used, such as billets, flats, etc., or flat products like plates.

Also, the filler pieces (1) that are placed in the frames (3) to make up the counter-weights (2) must comply with a number of specifications as to resistance to static, dynamic and shock loads. To comply with these specifications, some of the known concrete pieces (6) employ shell-like solutions, i.e. an external shell made of metal or plastic, which makes the unit more resistant. The problem with this solution, of placing an outer shell over the known concrete piece (6), is that it is very costly.

The filler piece (1) that is the subject matter of the invention, according to a first embodiment, is very fragile in the face of shock loads or dynamic loads, since the core (5) of metal material acts as if it were a ram upon impact, fracturing the walls of the concrete casing (4) that encases said core (5). The walls of the casing of the filler pieces (1) are thinner than the walls of the known concrete pieces (6), meaning that the concrete casing (4) of the filler pieces (1) must be reinforced. In order to reinforce the casing (4) of the filler piece (1) that is the subject matter of the invention, resins with cement-compatible polymers are used in combination with reinforcement fibers, thus obtaining increased resistance, complying with the required technical specifications.

Also, the known metal pieces (7) that are placed in the frame (3) are elements that must be handled by hand during the assembly of the elevator, and as such are subject to certain quality conditions, such that the cutting of each known metal piece (7) must be carried out with quality, making the cutting speed of the known metal pieces (7) relatively slow. Moreover, in the known metal pieces (7), a final deburring operation must be carried out upon the known metal pieces (7), wherein the burrs left when cutting the known metal piece (7) are removed.

In the filler pieces (1) that are the subject matter of the invention, according to the first embodiment, since the metal core (5) is not exposed and since it is also desirable for there to be a certain roughness to improve the coupling and adherence between the concrete of the casing (4) and the metal material of the core (5) (notches may even be made on the surface of the metal element to improve this adherence), the cutting speed is much higher, thus increasing productivity. Moreover, lastly the deburring operation is not necessary, since the burrs increase the adherence between the concrete of the casing (4) and the metal material of the core (5).

There is a second embodiment of the filler piece (1) that is the subject matter of the invention; in this second embodiment the metal material of the core (5) is a granular metal material so as to optimize the use made of said metal material, such that with this counter-weight piece (1) improvements are obtained both in the manufacturing process and in terms of saving on costs. It also helps to obtain the resistance required for the filler piece (1).

Once the proportions of granular metal material necessary to reach the target density have been established, the goal is to produce a granular metal material that comprises elements of different sizes, such that the amount of each differently-sized element comprised by the granular metal material provides a granulometric curve of the granular metal material, in such a way as give the granular metal material the density necessary in order to reach the target density of the elevator counter-weight piece (1).

In order to improve the granulometric curve of the granular metal material, and therefore the density of the granular metal material, bearing in mind the proportions of the differently-sized elements comprised by the granular metal material, one may choose to grind said granular metal material so as to have thin granular metal material and coarse metal material, thus optimizing the granulometric curve.

The granular metal material must comply with the following condition:

$${ρ}_{Metal}^{Apparent} \geq {ρ}_{Metal} ( \frac{{ρ}_{t} - {ρ}_{HDC}}{{ρ}_{Metal} - {ρ}_{HDC}} )$$

where the apparent density of the granular metal material is the mass of granular material that fits exactly within the dimensions of a receptacle, divided by the internal volume of this receptacle.

Thus, depending of the size, the shape of the grains, and the grain size of the granular metal material, this apparent density shall be higher or lower, and a suitable mixture of thin and coarse material improves the granulometric curve and the apparent density obtained.

The grain size of the granular metal material could be 0-10 mm, and the grain size of the ground granular metal material could be 0-6 mm. The maximum size may be adjusted according to the size and the conditions of the counter-weight to be manufactured.

The granular metal material has two possible origins, granular material made of iron and granular material made of steel.

The granular material made of iron may be worked by grinding, thus modifying the grain size of the iron material according to the requirements of the different pieces (1) of the different counter-weights, whereas in the case of the granular material made of steel, this grinding cannot be carried out, meaning that its grain size is dictated by the material that is received.

Moreover, it should also be added that the cost of the granular material made of steel is significantly higher than that of the granular material made of iron.

The cutting speed of the metal element of the core (5) is between 2 and 2.5 times higher than the manufacturing pace of known metal pieces (7), with the resulting reduction in costs.

The operation of preparing the counter-weights (2) as packages, in the traditional sense of depositing, on a pallet, known concrete pieces (6) and known metal pieces (7), which are placed in the frame (3) and make up the necessary load for an elevator with the pre-set target density, is much simpler, since with the filler pieces (1) that are the subject matter of the invention, putting together a package consists of simply depositing the filler pieces (1) necessary for the corresponding model.

This is due to the fact that with the filler pieces (1) that are the subject matter of the invention, the target density is obtained with a suitable proportion between the amount of metal material in the core (5) and the amount of concrete in the casing (4) in each filler piece (1), these amounts been set for each specific model.

Likewise, the more complex shapes in the geometry of each filler piece (1) of the counter-weight (2) are made by means of high-density cast and compacted concrete, which is easier to reproduce, whereas the metal material of the core (5) has the simplest shape possible.

The concrete used in the filler pieces (1) that are the subject matter of the invention, according to a first embodiment, is made up of iron and steel aggregate, a binder, a reinforcement fiber, and a plasticizing additive, whereas according to a second embodiment the concrete employed may forego the reinforcement fiber and the plasticizing additive.

The reinforcement fiber is preferably short fiber, measured out to between 300 and 900 grams per ton of concrete, 600 gr/tn of concrete being preferable.

The plasticizing additive is approximately 1.5% by weight over cement, this percentage being variable depending on the additive being used for the mixture.

The binder used in the concrete in the first embodiment, in turn, is made up of cement and resins with polymers, where copolymers of vinyl acetate and ethylene are used as resins, in a quantity that is within a range of 2% and 6% by weight over the amount of cement, 3% being preferable.

The amount of binder used in the concrete in the first embodiment of the filler piece (1) that is the subject matter of the invention is comprised between 7% and 12% by weight over the amount of aggregate, 10% being preferable.

Likewise, for the second embodiment, the binder of the concrete of the casing (4) is only cement, and is measured out with a percentage by weight over the mass of concrete according to the expression:

$${χ}_{cement} = \frac{c}{{ρ}_{t} {χ}_{HDC}}$$

where:
c is a parameter comprised between 0.2 and 0.5 tn/m³;
χ_{cement} is the percentage by weight of cement over the mass of concrete:
ρₜ is the target density of the mixture of concrete—granular metal material of each filler piece (1); and
χ_{HDC} is the percentage (0≦χ_{HDC}≦1) by weight of concrete.

The percentage by weight of metal material and concrete depends on the target density to be reached in each filler piece (1), on the density of the metal material, and on the density of the high-density concrete once shaped and hardened. The target density to be reached in the counter-weights that are the subject matter of the invention is comprised between 4.0 g/cm³ and 5.5 g/cm³.

The proportion between metal material and concrete is given by the following ratios:

$${χ}_{HDC} = \frac{{ρ}_{HDC}}{{ρ}_{t}} ( \frac{{ρ}_{Metal} - {ρ}_{t}}{{ρ}_{Metal} - {ρ}_{HDC}} )$$

$${χ}_{Metal} = \frac{{ρ}_{Metal}}{{ρ}_{t}} ( \frac{{ρ}_{t} - {ρ}_{HDC}}{{ρ}_{Metal} - {ρ}_{HDC}} )$$

where:
χ_{HDC} is the percentage (0≦χ_{HDC}≦1) by weight of high-density concrete,
χ_{Metal} is the percentage (0≦χ_{Metal}≦1) by weight of measured out metal material,
ρ_{HDC} is the final density of the compacted and hardened concrete,
ρ_{Metal} is the density of the metal material employed,
ρₜ is the target density of the mixture of concrete and metal material of each filler piece (1).

The invention is not intended to be limited to the specific embodiments described in this document; those skilled in the art may develop other embodiments in light of the description made herein. As such, the scope of the invention is defined by the following claims.

1. A filler piece (1) for an elevator counter-weight characterized in that it comprises a core (5) of metal material and a concrete casing (4), wherein said piece (1) comprises a combination of the concrete of the casing (4) and the metal material of the core (5) that has a target density comprised between 4.0 g/cm³ and 5.5 g/cm³.

2. The filler piece (1) for an elevator counter-weight, according to claim 1, characterized in that the metal material of the core (5) is a granular material.

3. The filler piece (1) for an elevator counter-weight, according to claim 1, characterized in that proportions by weight of granular metal material and concrete are a function of the target density, where the proportion by weight of concrete is given by the following expression:
$${χ}_{HDC} = \frac{{ρ}_{HDC}}{{ρ}_{t}} ( \frac{{ρ}_{Metal} - {ρ}_{t}}{{ρ}_{Metal} - {ρ}_{HDC}} )$$
where:
χ_{HDC} is the percentage by weight of concrete, and has a value that is comprised between 0 and 1,
ρ_{HCD} is a final density of the compacted and hardened concrete,
ρ_{Metal} is a density of the metal material employed,
ρₜ is the target density of the combination concrete—metal material of each filler piece (1).

4. The filler piece (1) for an elevator counter-weight, according to claim 1, characterized in that the proportion of metal material is given by the following expression:
$${χ}_{Metal} = \frac{{ρ}_{Metal}}{{ρ}_{t}} ( \frac{{ρ}_{t} - {ρ}_{HDC}}{{ρ}_{Metal} - {ρ}_{HDC}} )$$
where:
χ_{Metal} is a percentage by weight of measured out granular metal material, and has a value that is comprised between 0 and 1,
ρ_{HDC} is the final density of the compacted and hardened concrete,
ρ_{Metal} is the density of the metal material employed,
ρₜ is the target density of the combination concrete—metal material of each filler piece (1).

5. The filler piece (1) for an elevator counter-weight, according to claim 1, characterized in that the concrete of the casing (4) comprises:
iron and steel aggregate, and
a binder.

6. The filler piece (1) for an elevator counter-weight, according to claim 5, characterized in that the concrete of the casing (4) comprises:
at least one type of reinforcement fiber, and
and at least one plasticizing additive.

7. The filler piece (1) for an elevator counter-weight, according to claim 5, characterized in that the binder of the concrete of the casing (4) is cement, and is measured out with a percentage by weight over the mass of concrete according to the expression:
$${χ}_{cement} = \frac{c}{{ρ}_{t} {χ}_{HDC}}$$
where:
c is a parameter comprised between 0.2 and 0.5 tn/m³;
χ_{cement} is a percentage by weight of cement over the mass of concrete;
ρₜ is the target density of the mixture of concrete—granular metal material of each filler piece (1); and
χ_{HDC} is the percentage by weight of concrete, and has a value that is comprised between 0 and 1.

8. The filler piece (1) for an elevator counter-weight, according to claim 5, characterized in that the binder of the concrete of the casing (4) comprises cement and resins.

9. The filler piece (1) for an elevator counter-weight, according to claim 8, characterized in that the resins of the binder comprise copolymers of vinyl acetate and ethylene, such that a percentage by weight of the resins with respect to a total weight of the cement is in a range comprised between 2% and 6%.

10. The filler piece (1) for an elevator counter-weight (2), according to claim 5, characterized in that the binder comprises cement and microsilica, the microsilica being measured out at 10% over the amount of cement.

11. The filler piece (1) for an elevator counter-weight, according to claim 6, characterized in that the reinforcement fiber is of the short fiber type, measured out in a range comprised between 0 and 900 grams per ton of concrete.

12. The filler piece (1) for an elevator counter-weight, according to claim 6, characterized in that the plasticizing additive is approximately 1.5% by weight over the total cement weight.

13. The filler piece (1) for an elevator counter-weight, according to claim 2, characterized in that proportions by weight of granular metal material and concrete are a function of the target density, where the proportion by weight of concrete is given by the following expression:
$${χ}_{HDC} = \frac{{ρ}_{HDC}}{{ρ}_{t}} ( \frac{{ρ}_{Metal} - {ρ}_{t}}{{ρ}_{Metal} - {ρ}_{HDC}} )$$
where:
χ_{HDC} is the percentage by weight of concrete, and has a value that is comprised between 0 and 1,
ρ_{HDC} is a final density of the compacted and hardened concrete,
ρ_{Metal} is a density of the metal material employed,
ρₜ is the target density of the combination concrete—metal material of each filler piece (1).

14. The filler piece (1) for an elevator counter-weight, according to claim 2, characterized in that the proportion of metal material is given by the following expression:
$${χ}_{Metal} = \frac{{ρ}_{Metal}}{{ρ}_{t}} ( \frac{{ρ}_{t} - {ρ}_{HDC}}{{ρ}_{Metal} - {ρ}_{HDC}} )$$
where:
χ_{Metal} is a percentage by weight of measured out granular metal material, and has a value that is comprised between 0 and 1,
ρ_{HDC} is the final density of the compacted and hardened concrete,
ρ_{Metal} is the density of the metal material employed,
ρₜ is the target density of the combination concrete—metal material of each filler piece (1).

15. The filler piece (1) for an elevator counter-weight, according to claim 2, characterized in that the concrete of the casing (4) comprises:
iron and steel aggregate, and
a binder.

16. The filler piece (1) for an elevator counter-weight, according to claim 6, characterized in that the binder of the concrete of the casing (4) is cement, and is measured out with a percentage by weight over the mass of concrete according to the expression:
$${χ}_{cement} = \frac{c}{{ρ}_{t} {χ}_{HDC}}$$
where:
c is a parameter comprised between 0.2 and 0.5 tn/m³;
χ_{cement} is a percentage by weight of cement over the mass of concrete;
ρₜ is the target density of the mixture of concrete—granular metal material of each filler piece (1); and
χ_{HDC} is the percentage by weight of concrete, and has a value that is comprised between 0 and 1.

17. The filler piece (1) for an elevator counter-weight, according to claim 6, characterized in that the binder of the concrete of the casing (3) comprises cement and resins.

18. The filler piece (1) for an elevator counter-weight (2), according to claim 6, characterized in that the binder comprises cement and microsilica, the microsilica being measured out at 10% over the amount of cement.

19. The filler piece (1) for an elevator counter-weight, according to claim 7, characterized in that the reinforcement fiber is of the short fiber type, measured out in a range comprised between 0 and 900 grams per ton of concrete.

20. The filler piece (1) for an elevator counter-weight, according to claim 7, characterized in that the plasticizing additive is approximately 1.5% by weight over the total cement weight.
